(19) United States
(12) Patent Application Publication
(10) Pub. No.: US 2010/0212141 A1
(43) Pub. Date: Aug. 26, 2010

(54) Method of manufacturing coil and coil device

(76) Inventors: Kunihiro Ueda, Hong Kong (CN); Taiki Yamada, Hong Kong (CN); Osamu Harakawa, Hong Kong (CN)

Correspondence Address: NIXON & VANDERHYE, PC, 901 NORTH GLEBE ROAD, 11TH FLOOR, ARLINGTON, VA, 22203, US

(21) Appl. No.: 12/654,781

(22) Filed: Dec. 31, 2009

(30) Foreign Application Priority Data
Feb. 25, 2009 (JP) 2009-042379

(51) Int. Cl. H01P 11/00

(52) U.S. Cl. 29/600

(57) ABSTRACT

A thin film made of a conductive material is formed on one surface of a long-sheet-shaped flexible base. The flexible base formed with the thin film made of the conductive material is wound in a roll shape to fabricate an original roll of coils. The flexible base formed with the thin film made of the conductive material is unwound from the original roll of coils, and rewound around an outer periphery of a core to fabricate a wound body. The wound body is cut in a direction orthogonal to the longitudinal direction of the core to make a coil intermediary body. A cut surface of the coil intermediate body which is cut from the wound body is lapped. Lead wires are attached to both ends of a winding section comprised of the conductive material within the coil intermediary body. The foregoing steps are performed in sequence to manufacture a coil.

### BACKGROUND OF THE INVENTION

1. Field of the Invention

The present invention relates to a method of manufacturing a coil such as an antenna coil and a coil device.

2. Description of the Related Art

Conventionally, an RFID (Radio Frequency Identification) device, for example, a non-contact IC (integrated circuit) card or the like, contains a thin antenna coil for making radio communications. As one type of antenna coil, a winding-type antenna coil is formed by winding a copper wire or the like a plurality of times. However, as described in Japanese Patent Application Laid-open No. 2001-256457, film-type antenna coils have been in the mainstream. The film-type antenna coil is created by forming a metal foil such as aluminum foil, copper foil, or the like on an insulating board (base film board), and subsequently patterning the metal foil by etching, or by sputtering or applying a conductive paste such as a silver paste on an insulating board (see Paragraph [0003] of Japanese Patent Application Laid-open No. 2001-256457).

On the other hand, Japanese Patent Application Laid-open No. 364003/92 discloses a method of manufacturing a spiral thin film resonator coil by forming a conductive thin film on an insulating film and then winding the resulting product in a spiral form.

Japanese Utility-Model Application Laid-open No. 17205/94 discloses a method of forming a coil by winding and solidifying a conductive thin film formed with an electrically insulating coating to fabricate a rod-like conductive film wound body, and cutting the wound body in sections.

According to the method described in Japanese Patent Application Laid-open No. 2001-256457, a thin antenna coil suitable for incorporation in an RFID device can be manufactured. However, antenna coils must be formed one by one using a method which involves etching, sputtering, application of a conductive paste, and the like, so that this method cannot manufacture a plurality of antenna coils in a batch. Accordingly, this method is inferior in manufacturing efficiency and is not suitable for mass production.

According to the method described in Japanese Patent Application Laid-open No. 364003/92, since a considerably large coil is manufactured, as is apparent from the description of each drawing, this method is not suitable for manufacturing a thin coil such as an antenna coil or the like contained in an RFID device.

According to the method described in Japanese Utility-Model Application Laid-open No. 17205/94, this method can manufacture relatively thin coils by reducing the width by which the wound body is cut, and is suitable for mass producing the same coils. However, for manufacturing coils which have different numbers of turns, this method must be performed again from the step of forming an electrically insulating film on a conductive thin film and therefore suffers from low manufacturing efficiency.

### SUMMARY OF THE INVENTION

It is an object of the present invention to provide a coil manufacturing method which is capable of efficiently manufacturing a thin coil such as an antenna coil, and is capable of readily manufacturing coils which differ in the number of turns, and to provide a method of manufacturing a coil device which includes such a coil.

A coil manufacturing method of the present invention comprises the steps of forming a thin film made of a conductive material on one surface of a long-sheet-shaped flexible base, winding the flexible base formed with the thin film made of the conductive material in a roll shape to fabricate an original roll of coils (an original roll for fabricating coils), unwinding the flexible base formed with the thin film made of the conductive material from the original roll of coils, and rewinding the flexible base around the outer periphery of a core to fabricate a wound body, cutting the wound body in a direction orthogonal to the longitudinal direction of the core to make a coil intermediary body, lapping a cut surface of the coil intermediate body which is cut from the wound body, and attaching lead wires to both ends of a winding section comprised of the conductive material within the coil intermediary body. In the step of fabricating a wound body, the flexible base formed with the thin film made of the conductive material, which is unwound from the original roll of coils, is rewound around the outer periphery of the core by a length corresponding to the number of turns required for the coil to be manufactured.

The step of forming a thin film made of a conductive material on the flexible base may be performed simultaneously with the step of fabricating an original roll of coils.

The step of lapping the cut surface of the coil intermediate body may be performed until the coil intermediate body is thinned to a desired thickness.

A method of manufacturing a coil device of the present invention comprises each step of the coil manufacturing method described above, and a step of disposing a sheet-shaped base material so as to cover the coil in which the lead wires have been attached to both ends of the conductive material.

According to the present invention, a coil and a coil device can be manufactured with high efficiency. In particular, by previously fabricating an original roll of coils, even in the case of manufacturing coils that have different numbers of turns and coil devices that have such coils, these coils and coil devices can be efficiently manufactured by repetitions of relatively easy operations without the need for repeatedly performing complicated operations.

While exemplary embodiments of the present invention have been described using specific terms, such description is for illustrative purposes only, and it is to be understood that changes and variations may be made without departing from the spirit or scope of the following claims.

### BRIEF DESCRIPTION OF THE DRAWINGS

FIG. 1 is a flow chart showing a method of manufacturing a coil and a coil device according to the present invention;

FIG. 2 is a perspective view showing a flexible base formed with a thin film made of a conductive material;

FIG. 3 is a perspective view showing an original roll of coils fabricated by winding a flexible base formed with a thin film;

FIG. 4 is a perspective view showing a wound body which is fabricated by rewinding a flexible base formed with a thin film from an original roll of coils;

FIG. 5A is a plan view showing a coil intermediary body fabricated by cutting a wound body;

FIG. 5B is a cross-sectional view of the coil intermediary body shown in FIG. 5A;

FIG. 6 is a plan view showing a coil in which lead wires are attached to the coil intermediary body shown in FIGS. 5A, 5B;

FIG. 7 is a plan view showing a coil in which lead wires are attached to another exemplary coil intermediary body; and

FIG. 8 is a plan view showing a coil device in which the coil shown in FIG. 7 is covered with a sheet-shaped base material.

### DETAILED DESCRIPTION OF THE EXEMPLARY EMBODIMENTS

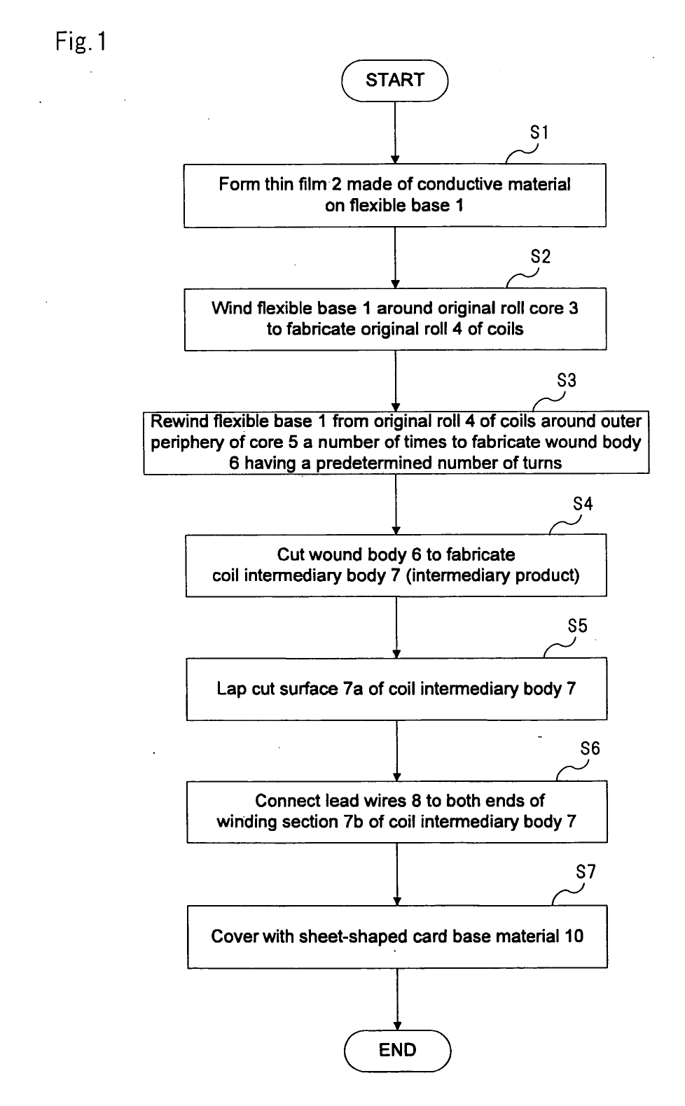

An exemplary embodiment of the present invention will be described below referring to a flow chart shown in FIG. 1. In this embodiment, a thin coil is fabricated, such as an antenna coil for use in an RFID device, by way of example.

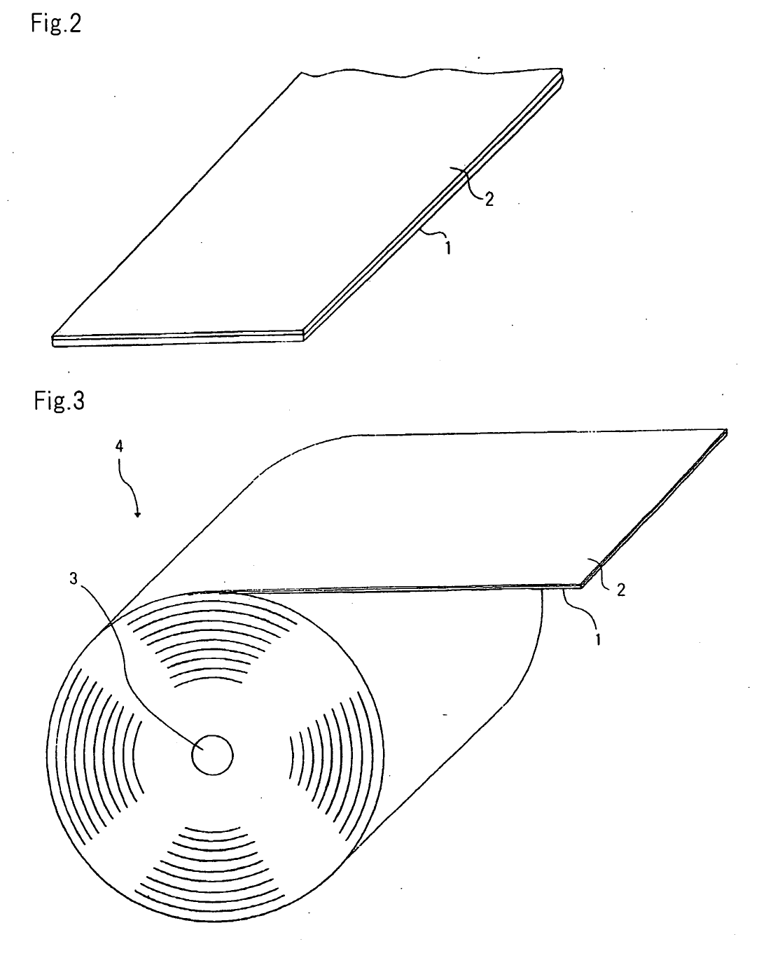

In this embodiment, first at step S1, thin film 2 made of a conductive material is formed on one surface of a long-sheet-shaped flexible base 1 made of an insulating synthetic resin film or the like, as shown in FIG. 2. This thin film 2 is formed by coating a conductive paste containing a metal such as silver on flexible base 1, or by using a known vacuum deposition method (for example, metal deposition, sputtering, ion plating, or the like). As an example, thin film 2 made of a conductive film is formed over the entirety of very large flexible base 1 having a width of 1 m and a length of 10,000 m. Thin film 2 preferably has a thickness of approximately 10 μm-100 μm from the viewpoint of thermal conductivity. However, not limited to that, the thickness of thin film 2 is determined as appropriate in consideration of other properties, the number of turns of a coil to be manufactured, and the like. Thin film 2 may be made of a variety of known conductive materials such as a metal, a conductive metal oxide, and the like.

When thin film 2 is formed by vapor deposition, a metal, which is a raw material, is generally heated using an electron beam, heater, inductive heating, or the like. The metal, i.e., raw material, is preferably copper, aluminum, silver, gold, or the like, in view of the properties of the coil, and among them, copper and aluminum are particularly preferable in view of cost. Also, a magnetic metal such as iron can be used if it is applied with a protective coating which exhibits sufficient corrosion resistance.

On the other hand, when thin film 2 is formed by application, a coating material is created by such a method as kneading, dilution, dispersion, or the like using conductive particles such as metal powder, carbon, or the like, a known binder, a dispersant, other additives, and the like, and the coating material can be applied on flexible base 1 by a known method using an extrusion type nozzle or the like.

Flexible base 1 formed with thin film 2, thus fabricated, is wound around original roll core 3, which is a jig for fabricating an original roll 4 of coils, in a roll shape, as shown in FIG. 3, to fabricate original roll 4 of coils (original roll 4 for fabricating coils) at step S2. As an example, original roll core 3 is in the form of a cylinder which has a length of one meter, equal to the width of flexible base 1, and a diameter of 250 mm.

In this regard, the foregoing description has been given of step S1 for forming thin film 2 on flexible base 1, and step S2 for winding flexible base 1 formed with thin film 2 to fabricate original roll 4 of coils, which are described as independent steps. Actually, however, step S1 and step S2 can be simultaneously performed in such a manner that a portion of flexible base 1 formed with thin film 2 is sequentially wound around original roll core 3, while forming thin film 2 on flexible base 1.

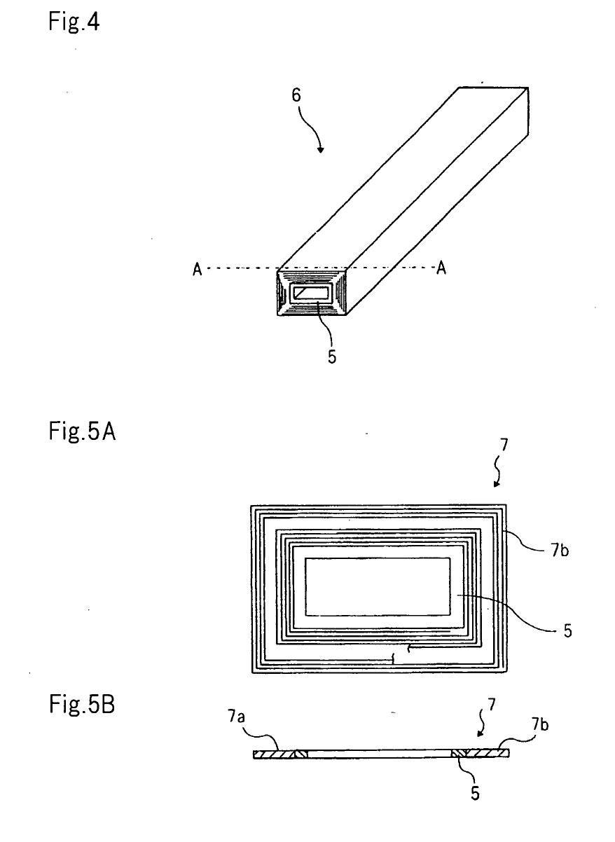

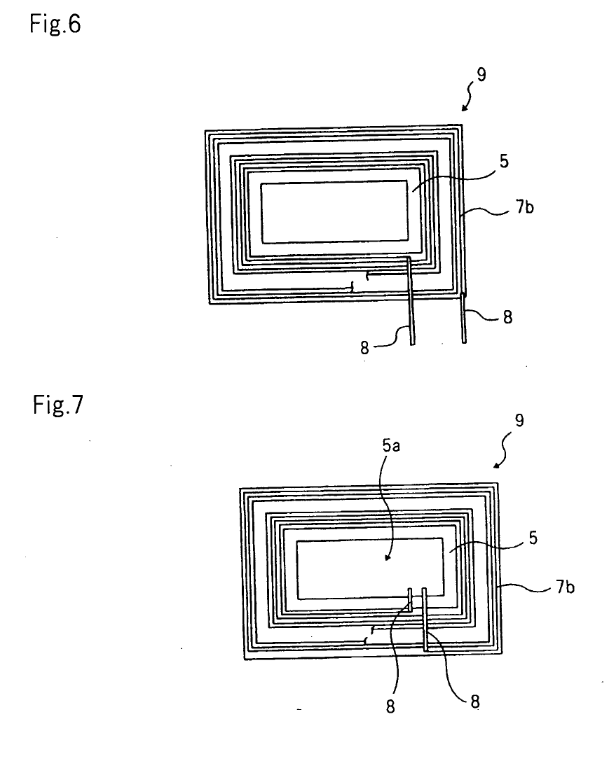

After original roll 4 of coils is fabricated in the foregoing manner, individual coils are fabricated. At step 3, a required amount of flexible base 1 formed with thin film 2 is unwound from original roll 4 of coils, and rewound around the outer periphery of core 5, as shown in FIG. 4 a number of times equal to the required number of turns for coil 9 to be manufactured (see FIGS. 6, 7). In this way, wound body 6 is fabricated with thin film 2 and flexible base 1 wound around the outer periphery of core 5 a desired number of turns. Core 5 has a hollow prismatic shape having a height of 30 mm, a width of 50 mm, and a length of one meter, by way of example, and flexible base 1 formed with thin film 2 is wound around the periphery of core 5 twenty times. In this way, flexible base 1 formed with thin film 2 is unwound, rewound, and cut. The rest of original roll 4 of coils, after being cut, is preserved for manufacturing coil 9 which has a different number of turns in the future.

At step S4, wound body 6 is cut (in sections) in a direction orthogonal to the longitudinal direction of core 5, for example, along cut line A-A shown in FIG. 4 to make thin coil intermediary body 7 (intermediary product) (for example, 0.4 mm thick), as shown in FIGS. 5A, 5B. Generally, this cutting is performed using a slicer (not shown) which has a blade having a thickness of approximately 0.1 mm. In this event, wound body 6 can be cut at one time. Alternatively, winding section 7b having a smaller thickness may be cut using a blade which is thinner, while core 5 having a larger thickness may be cut using a blade having a standard thickness. Further alternatively, wound body 6 may be cut by driving a cutter-like blade into wound body 6, in which case, however, difficulties are encountered in management of the edge of the blade. Accordingly, wound body 6 is preferably cut by rotating a circular blade having a thickness of approximately 0.07-0.15 mm. However, the present invention is not limited to these methods, but may be realized with laser-based cutting, etching-based cutting in vacuum, and the like. Methods of cutting wound body 6 may be selected and used as appropriate in accordance with applications of final coil 9 and coil device 12 (see FIGS. 6 -8). In this regard, the thickness in which coil intermediary body 7 is cut is preferably brought as close as possible to the thickness of final coil 9 which is implemented by lapping at next step S5.

Next, at step S5, cut surface 7a (upper surface in FIG. 5B) of coil intermediary body 7, shown in FIGS. 5A, 5B, is lapped. This results in refinement of intermediary body 7 to a desired thickness (for example, 0.2 mm), smoothing of end face 7b, and removal of contaminations and the like which can be produced during the cutting. A variety of methods can be used for the lapping, such as mechanical lapping which employs a lapping plate, slurry lapping performed with a slurry introduced between the product and lapping plate, sheet lapping using a sheet for lapping, CMP (Chemical

Mechanical Polishing), dry etching performed in vacuum, and the like. Among these methods, the CMP method is preferred because a lapped surface presents a very smooth mirror surface. However, the present invention is not limited to the methods illustratively listed herein, and a lapping method may be determined in accordance with particular conditions. If winding sections 7b come into contact with each other after lapping, the characteristics of coil intermediary body 7 will deteriorate. Therefore, a test may be conducted by observing winding sections 7b with an optical microscope, such that if winding sections 7b are in contact and short-circuited with each other, winding sections 7b may be released from mutual contact by shaving contacting portions with a file.

Next, as shown in FIG. 6, lead wires 8 are attached respectively to both ends of winding section 7b comprised of conductive material (thin film 2) formed on flexible base 1 within coil intermediary body 7 at step S6. In this way, coil 9 is completed. Specifically, lead wires 8 are connected to both ends of winding section 7b using a conductive paste or the like. Also, lead wires 8 are copper wires or the like, and lead wires 8, except for portions that are connected to ends of winding section 7b, are preferably coated with an insulating material, for example, polyethylene terephthalate (PET), polyethylene naphthalate (PEN), aramid resin, polyether ether keton (PEEK), enamel, or the like, in order that the coated portions may prevent short-circuit even if the lead wires come into contact with winding section 7b.

FIG. 7 shows another exemplary coil 9 different from coil 9 shown in FIG. 6. In coil 9 shown in FIG. 7, lead wires 8 attached to both ends of winding section 7b protrude into hollow section (hollow core section) 5a inside of core 5.

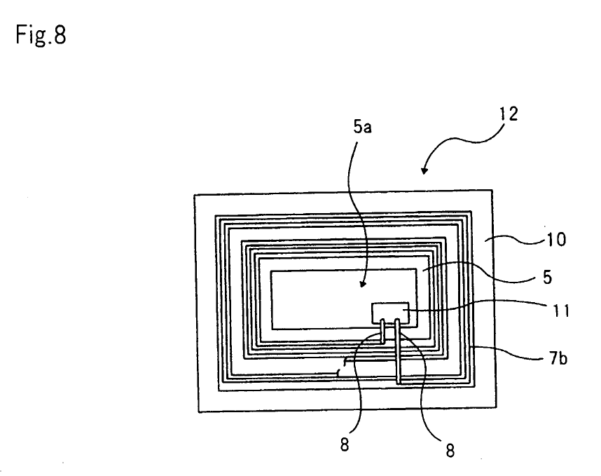

Further, FIG. 8 shows an exemplary IC card, one type of RFID device, which comprises coil device 12 including coil 9 shown in FIG. 7. In this example, integrated circuit (IC) 11 is disposed within hollow section 5a of core 5 of coil 9 described above, and this IC 11 is connected to lead wires 8 attached to winding section 7b. Then, card base material 10 in a sheet shape, made of synthetic resin, paper, or the like, is disposed to cover coil 9 and IC 11 (step S7). Specifically, coil 9 and IC 11 are adhered to card base material 10, or are coated with card base material 10. In this way, coil device 12 is fabricated such that it forms part of the IC card.

For manufacturing a plurality of coils 9 having the same number of turns, wound body 6 shown in FIG. 4 is cut several times in order to obtain a plurality of coil intermediary bodies 7 having desired thicknesses (step S4) respectively, and subsequently, cut surfaces 7a are lapped (step S5), and then lead wires 8 are attached (step S6), thereby making it possible to manufacture multiple coils 9 similar to coil 9 shown in FIGS. 6-8. A plurality of coils 9 thus manufactured and coil devices 12 which include them have the same number of turns, but can vary in thickness.

On the other hand, for manufacturing coil 9 having a different number of turns, flexible base 1 formed with thin film 2 is unwound from original roll 4 of coils shown in FIG. 3 and is wound around the outer periphery of core 5 a number of times equal to the number of turns of coil 9 to be newly manufactured, followed by cutting of flexible base 1. Subsequently, wound body 6 is cut (step S4), cut surface 7a is lapped (step S5), and lead wires 8 are attached (step S6). According to the present invention, since original roll 4 of coils has been previously fabricated, it is not necessary to repeat the process from the formation of thin film 2, that is made of a conductive material, each time that coil 9 is manufactured in order to have a different number of turns. Stated another way, by previously providing original roll 4 of coils, which can be used for general purposes, it is possible to readily and rapidly manufacture coils 9 which have various numbers of turns and to readily and rapidly manufacture coil devices 12 including such coils 9. Particularly, step S3 (re-winding operation) for fabricating wound body 6 and subsequent steps all involve relatively simple mechanical operations. The present invention eliminates the need for repeatedly performing relatively complicated operations such as the formation of thin film 2, comprised of a conductive material, by a vacuum deposition method, application of a conductive paste, or the like (step S1). Accordingly, the present invention provides extremely large practical advantages particularly for mass producing coils 9 and coil devices 12 which are not of a single type.

For reference, coil 9 for use as an antenna coil generally resonates at frequencies in the order of MHz when it has a number of turns in a range of several turns to 20 turns, and resonates at frequencies in the order of kHz when it has a number of turns approximate to several hundreds of turns. Accordingly, the number of turns is dominated by a frequency band in which coil 9 is to be used. According to the present invention, it is possible to readily manufacture, using previously fabricated same original roll 4 of coils, coil 9 which has a number of turns equal to or less than 20 for use in a frequency band in the order of MHz as well as coil 9 which has a number of turns approximate to several hundreds for use in a frequency band in the order of kHz. Operational efficiency is extremely high because the present invention eliminates the need for repeatedly performing the formation of thin film 2 by a vacuum deposition method or the like, which is most complicated.

The present invention is not limited to manufacturing of the antenna coil described above, but can be applied to manufacturing of any coil and coil device.

### EXAMPLES

Specific examples will be described for implementing steps S1-S7 in the embodiment of the present invention described above.

First, thin film 2 made of copper having a thickness of 5,000 angstrom was deposited on the entire surface of flexible base 1 made of PET film (made by Toray Industries, Inc.) having a thickness of 50 μm, by vapor deposition (step S1). Then, this flexible base 1 formed with thin film 2 was wound around original roll core 3 to fabricate original roll 4 of coils (step S2). Then, flexible base 1 formed with thin film 2 was unwound from original roll 4 of coils, wound around core 5 twenty times, and cut to fabricate wound body 6 (step S3). Then, wound body 6 was cut using a slicer made by Nachi-Fujikoshi Corp. to make coil intermediary body 7 having a thickness of 0.4 mm (intermediary product) (step S4). Further, cut surface 7a was lapped using a lapping sheet of WA 1000, until coil intermediary body 7 was thinned to a desired thickness (0.2 mm) (step S5). In this event, copper winding sections 7b (section comprised of thin film 2) were partially lapped with sand paper such that copper winding sections 7b do not come into contact with each other after lapping, and a confirmation was made, using an optical microscope at magnification of 200×, that winding sections 7b were not in contact with each other on the surface of coil intermediary body 7. Subsequently, lead wires 8 were attached respectively to both ends of winding section 7b of coil intermediary body 7 through epoxy resin (step S6). To confirm the connections of lead wires 8 with winding section 7b, a tester was used to examine a conductive state from one lead wire 8 to the other lead wire 8. Then, the inductance was measured at a frequency of 13.56 MHz.

Here, coils 9 were fabricated using four types of cores 5 made of vinyl chloride resin, specifically, a small cylindrical hollow core, a small prismatic hollow core, large cylindrical hollow core, and a large prismatic hollow core, respectively. Table 1 shows the dimensions of each core 5 and respective inductance measuring results. In this regard, Table 1 includes rows of “outside dimension” and “inside dimension” which indicate the outer diameter and inner diameter for a cylindrical hollow core, and the length and breadth for a prismatic hollow core, respectively.

TABLE 1

| | | | | Small |
|---|---|---|---|---|
| | Large | Small | Large | Prismatic |
| | Cylindrical | Cylindrical | Prismatic | Hollow |
| Type of Core | Hollow Core | Hollow Core | Hollow Core | Core |
| Outside | 31 | 101 | 35 × 33 | 88 × 85 |
| Dimension | | | | |
| (mm) | | | | |
| Inside | 30 | 100 | 34 × 31 | 87 × 84 |
| Dimension | | | | |
| (mm) | | | | |
| Thickness (mm) | 0.2 | 0.2 | 0.2 | 0.2 |
| Number of | 20 | 20 | 20 | 20 |
| Turns | | | | |
| Inductance (μH) | 7.1 | 24 | 16.5 | 70 |

While exemplary embodiments of the present invention have been described using specific terms, such description is for illustrative purposes only, and it is to be understood that changes and variations may be made without departing from the spirit or scope of the following claims.

1. A coil manufacturing method comprising the steps of:
forming a thin film made of a conductive material on one surface of a long-sheet-shaped flexible base;
winding said flexible base formed with said thin film made of the conductive material in a roll shape to fabricate an original roll of coils;
unwinding said flexible base formed with said thin film made of the conductive material from said original roll of coils, and rewinding said flexible base around an outer periphery of a core to fabricate a wound body;
cutting said wound body in a direction orthogonal to a longitudinal direction of said core to make a coil intermediary body;
lapping a cut surface of said coil intermediate body which is cut from said wound body; and
attaching lead wires to both ends of a winding section comprised of the conductive material within said coil intermediary body.

2. The coil manufacturing method according to claim 1, wherein said step of fabricating a wound body comprises rewinding said flexible base formed with said thin film made of the conductive material, rewound from the original roll of coils, around the outer periphery of said core a number of times equal to a number of turns required for a coil to be manufactured.

3. The coil manufacturing method according to claim 1, wherein said step of lapping the cut surface of said coil intermediate body is performed until said coil intermediate body is thinned to a desired thickness.

4. A method of manufacturing a coil device comprising:
the steps of the coil manufacturing method according to claim 1; and
a step of disposing a sheet-shaped base material so as to cover said coil in which said lead wires have been attached to both ends of the conductive material.
